(19) United States
(12) Patent Application Publication
(10) Pub. No.: US 2019/0284819 A1
(43) Pub. Date: Sep. 19, 2019

(54) DIGITAL COATING AND PRINTING

(71) Applicant: CERALOC INNOVATION AB, Viken (SE)

(72) Inventors: Darko PERVAN, Viken (SE); Tony Pervan, Stockholm (SE)

(73) Assignee: CERALOC INNOVATION AB, Viken (SE)

(21) Appl. No.: 16/428,257

(22) Filed: May 31, 2019

Related U.S. Application Data
(63) Continuation of application No. 13/938,589, filed on Jul. 10, 2013, now abandoned.
(60) Provisional application No. 61/671,249, filed on Jul. 13, 2012.

(51) Int. Cl. E04F 15/04; B44C 5/04; B41M 7/00; B05D 5/06; B44C 1/24

(52) U.S. Cl. CPC E04F 15/043; B44C 5/0476; B41M 7/0045; E04F 15/045; Y10T 428/24884; B44C 1/24; E04F 15/042; Y10T 428/24612; B05D 5/06

(57) ABSTRACT

Building panels, especially floor panels and a method to produce such building panels that include a decorative surface and a transparent protective layer, which is applied by a digital coating. Also, a vision control system that may be used to adapt a digital print or a digital embossing to a specific panel surface.

### CROSS REFERENCE TO RELATED APPLICATIONS

The present application claims the benefit of U.S. application Ser. No. 13/938,589, filed on July 140, 2013, and U.S. Provisional Application No. 61/671,249, filed on Jul. 13, 2012. The entire contents of U.S. application Ser. No. 13/938,589 and U.S. Provisional Application No. 61/671,249 are hereby incorporated herein by reference in their entirety.

### TECHNICAL FIELD

The disclosure generally relates to the field of panels with a decorative wear resistant surface, preferably floor and wall panels. The disclosure relates to building panels with such decorative surfaces and to production methods to produce such panels.

### FIELD OF APPLICATION

Embodiments of the present invention are particularly suitable for use in floors, which may be formed of floor panels comprising a core, a decorative layer and a transparent wear resistant layer above the decorative layer. The following description of technique, problems of known systems and objects and features of the invention will therefore, as a non-restrictive example, be aimed at this field of application and in particular at floorings which are similar to traditional wood and laminated floorings.

It should be emphasized that embodiments of the invention may be used to produce a surface layer in any type of panels for example in building panels such as wall panels, ceilings, and furniture components and similar.

### BACKGROUND

The majority of all laminate floors are produced according to a production method generally referred to as Direct Pressed Laminated. Such laminated floors comprise a core of a 6-12 mm fibre board, a 0.2 mm thick upper decorative surface layer of laminate and a 0.1-0.2 mm thick lower balancing layer of laminate, plastic, paper or like material.

The surface layer of a laminate floor is characterized in that the decorative and wear properties are generally obtained with two separate layers of paper, one above the other.

The decorative layer is generally a printed paper and the wear layer is a transparent overlay paper, which comprises small aluminium oxide particles.

The printed decorative paper and the overlay are impregnated with melamine resins and laminated to a wood fibre based core in large laminate presses where the resin cures under high heat and pressure and the papers are laminated to the core material.

Laminate floor are produced as large boards, generally with a size of 2.1*2.7 m and they are after pressing divided into several individual floor panels, generally with a size of about 1.3*0.2 m. The edges are thereafter machined and provided with mechanical locking systems.

Laminated floors may also be produced with printing technology. One advantage is that the pressing operation may be avoided and that no printed papers are needed to provide a decorative wear resistance surface.

Floor panels with a Direct Printed Laminate surface comprise the same type of HDF core as DPL. The décor is printed directly onto the core. The production process is rather complicated and is only cost efficient in very large production volumes.

In a first step a combination of pigmented, water-based primers and sealers are applied on the core in order to provide the adhesion to the core and a basic colouration. Such coating is below referred to as adhesion coating.

Hydro printing inks are used to print the décor by a multicolour printing press with rollers that print directly onto the pre-sealed core. The printed décor layer must be protected against wear. In some cases a paper based overlay is used and the board is pressed in a traditional laminate press. The most common method to achieve high abrasive strength is to use, anti-abrasive UV sealers, which are then applied on the print by rollers and cured by UV. Structured and synchronised surfaces may also be produced by embossed rollers. Several layer are applied on the print. Base coats are used to build up the thickness of the protective layer and top coats are used to provide the final structure and scratch resistance. Embossed structures may be formed by embossed rollers that also may have a structure that is in register with the printing cylinders.

Direct printing technology may be replaced with digital printing technology that is much more flexible and small production volumes can be economically manufactured. The difference between these two methods is mainly the printing step where printing rollers are replaced by a digital non-contact printing process and where the desired image is directly applied onto the pre-finished core. The final transparent coating which protects the digital image and the structured surfaces are usually of the same type as used in direct printing. Any types or printed images may be created but the surface structure is always limited to the form of the embossed rollers or structured films that are pressed against the surface.

Digital printing may also be used to print on a paper sheet that is used in conventional laminate production. The digital print may be applied on the upper side of a decorative paper comprising a base colour or on the lower side of the overlay and may be made prior or after impregnation. The print may also be made on a raw paper, with or without a base colour and the paper may be indirectly impregnated during pressing by resins from powder, a liquid layer or impregnated paper applied under and over the digitally printed paper. The raw paper may be connected to the core prior to the digital printing step and this allows that thinner raw paper may be used and positioning problems may be reduced.

Recently new “paper free” floor types have been developed with solid surfaces comprising a substantially homogenous mix of fibres, binders and wear resistant particles. Such floor is referred to as WFF.

The wear resistant particles are preferably aluminium oxide particles, the binders are preferably thermosetting resins such as amino resins and the fibres are preferably wood based. In most applications decorative particles such as for example colour pigments are included in the homogenous mix. In general, all these materials are preferably applied in dry form as a mixed powder on a HDF core and cured under heat and pressure to a 0.1-1.0 mm solid layer.

Several advantages over known technology and especially over conventional laminate, floorings may be obtained:
The wear resistant surface layer, which is a homogenous mix, may be made much thicker and a wear resistance is achieved, which is considerably higher.
New and very advanced decorative effects may be obtained with deep embossing and by separate decorative materials, which may be incorporated into the homogenous surface layer and coordinated with the embossing.
An increased impact resistance may be reached with a homogenous surface layer, which is thicker and has a higher density.
The homogenous surface layer may comprise particles that have a positive impact on sound and moisture properties.
Production costs may be reduced since low cost and even recycled materials may be used and several production steps may be eliminated.

Powder technology is very suitable to produce a decorative surface layer, which is a copy of stone and ceramics. It is however more difficult to create designs such as, for example, wood decors. However, recently digital powder printing has been developed and it is possible to create very advanced designs of any type by injecting a digital print into the powder prior to pressing.

Floors with a surface of wood are produced in many different ways. Traditional solid wood floors have developed into engineered floors with wood layers applied on a core made of wood lamellas, HDF or plywood. The majority of such floors are delivered as pre finished floors with a wood surface that is coated with several transparent layers in the factory. Wood floorings are one of the largest applications for the Roll-coat/UV-curing process that applies multi-layered coating structures to seal and protect the wood surface. Generally environmentally friendly water based UV cured polyurethane is used for the transparent protective layers. This application process generally comprises application of several types of transparent layers—UV primers, UV putties, UV sealers and UV topcoats. Each layer of coating is given its own specific function. Surface characteristics like abrasion resistance, hardness, scratch resistance etc. may be adjusted in order to meet different quality requirements. All such layers are applied by roller coaters and each individual layer is UV cured. A high quality wood floor may comprise a transparent protective layer of about 60-120 gr/m2 and there may be about 5-10 layers or more applied in steps by rollers with intermediate UV curing.

As a first step an adhesion coat is rolled on to form the bond between the wood and the subsequent finish coats. Depending on the wood species used in the floor and the desired final look, the following step may be a filler station, where clear UV filler may be applied and an UV oven cures the filler in one or several steps. The next steps are the application of the base coats that provides the main thickness of the transparent surface and finally the top finish comprising one or several top coats is applied with roller coaters. The number of coats used depends on the manufacturer, but each coat is followed by a trip through a UV curing oven.

Almost all producers of high quality wood floorings use wear resistant particles such as aluminium oxide particles in some or several layers in order to increase the wear resistance of the transparent surface. Transparent anti scratch topcoats contain small nano-particles, which offers high levels of scratch resistance.

Recently some laminate floors have been produced with a transparent UV based topcoat above the resin impregnated surface, for example over a melamine formaldehyde impregnated décor paper or overlay, in order to provide a smoother surface that is similar to wood. Even floors with a foil surface or a PVC surface, so called LVT floors, use a transparent polyurethane coating as a top coat in order to improve the stain resistance and wear resistance of vinyl floors.

Transparent protective layers applied and structured by roller are very important parts of the floor surface technology and it would be a major advantage if such applications may be made in a more cost efficient and flexible way and with improved properties mainly related to design and quality.

### Definition of Some Terms

In the following text, the visible surface of the installed floor panel is called “front side”, while the opposite side of the floor panel, facing the sub floor, is called “rear side”. By “surface layer” are meant all layers which give the panel its decorative properties and its wear resistance and which are applied to the core closest to the front side covering preferably the entire front side of the floorboard.

By “coating” is meant a layer of a substance spread above a surface for protection or decoration.

By “print” is meant a décor or image. By “adhesion coating” is meant an application of layers or primers that are used to improve the connection between a core material and other layers applied on the core. By “base coat” is meant layers that are used to build up the thickness of transparent protective layers. By “top coat” is meant upper layers applied on the base coat in order to provide scratch resistance and final gloss levels.

By “up” is meant towards the front side and by “down” towards the rear side.

By “pigments for digital print ink” is meant a material that changes the colour of reflected or transmitted light as the result of wavelength-selective absorption.

By “dye ink” is meant a coloured substance that has an affinity to the substrate to which it is being applied. The dye is generally applied in an aqueous solution, which also may contain a binder, and may require a mordant to improve the fastness of the dye on the fibre. In contrast to pigments that are small insoluble particles, a dye is completely soluble like sugar in water.

By “aqueous or water based ink” is meant an ink where water is used as liquid substance in the ink. The water-based liquid carries the pigments. A binder is present in the system as well to bind the pigments to the substrate.

By “solvent based ink” is meant ink that generally contains three major parts such as a fluid carrier, pigments and resins. Technically, solvent ink refers generally only to the oil-based carrier portion of the ink that keeps the other components in liquid form and once applied to a surface through jetting evaporates.

By “UV curable Inks or coating” is meant an ink or coating that after application is cured by exposure to strong UV-light in an UV oven.

### Known Technique and Problems Thereof

A common feature for all such floors as described above, that comprise a transparent protective layer above the decorative layer, is that such transparent layers are applied by rollers. Problems related to application of transparent layers by roller will be described below with reference to wood flooring.

FIG. 1a shows a roll coating of a panel 1 that is transported under rollers and UV ovens on a conveyor 21. Transparent layers L1, L2, L3 are applied by rollers 22a-c and cured in several steps by UV ovens 23a-c.

FIG. 1b shows roll coating of a floor panel 1 with a wood surface 2 and a mechanical locking system comprising a tongue 10 and a tongue groove 9 for vertical locking of adjacent edges and a strip 6 with a locking element 8 that cooperated with a locking groove 14 in an adjacent edge for horizontal locking of the edges. Roll coating is complicated when the coating is applied on a surface that is not completely flat. It is difficult to avoid marks in the short edges of a floor panel where a roll 22 meets the edge 15a and leaves the edge 15b. Such problems are especially related to floor panels which are coated as individual panels, i.e. not as large boards that are divided into several individual floor panels after coating, and to individual floor panels which are prior to the coating of the surface provided with a mechanical locking system that comprise an edge that is not completely supported vertically by a lower edge 16. Bevels 15a,b at long and short edges are also difficult to coat and overflow of the coating on the edges may change the locking geometry. Individual floor panels may be coated prior to the forming of the locking system and/or the bevels. This method gives very sharp edges that may comprise small cracks and the bevels must be coated in a separate operation where overflow of the coating material may create undesired visual edge effects.

The coating lines with roller stations and UV curing ovens are generally very long and may be 50-100 m. The rubber rollers have a limited lifetime and must be cleaned when new coating layers are applied. Structured rollers are expansive and only a pre-determined embossed pattern may be formed that is not possible to change during production unless the structured roller is replaced with another embossed roller. It would be a major advantage if the coating may be applied with improved precision and flexibility and with a non-contact method.

The general technology, which is used by the industry to provide a digital printing, is described below. The methods described below may be used separately or in combinations to create a digital print or a digital application of a substance in the embodiments of this disclosure.

High definition digital printers use a non-impact printing processes. The printer has print heads that “fire” drops of ink from the print heads to the substrate in a very precise manner.

Multipass printing, also called scanning printing, is a printing method where the printer head moves transverse above the substrate many time to generate an image. Such printers are slow but one small print head can generate a bigger image.

Industrial printers are generally based on a Single Pass printing method, which uses fixed printer heads, with a width that corresponds to the width of the printed media. The printed substrate moves under the heads. Such printers have a high capacity and they are equipped with fixed print heads that are aligned one after each other in the feeding direction. Each head prints one colour. Such printers may be custom made for each application.

FIG. 1c shows a single pass printer 35 comprising five digital print heads 30a-e, which are connected with ink pipes 32 to ink containers 31 that are filled with ink of different colours. The ink heads are connected with digital data cables 33 to a digital control unit 34 that controls the application of the ink drops and the speed of the conveyor 21 that must be able to displace the panel under the print heads with high precision in order to guarantee a high quality image comprising several colours. The ink is generally circulated through the print head, the ink pipes and the ink container in order to avoid clogging of the nozzles.

A normal width of an industrial print head is about 6 cm and any lengths may be printed. Wide areas of 1-2 m may be printed with digital printers comprising several rows of print heads aligned side by side.

Recently print heads have been developed that may apply 5 different colours and that may be about 20-30 cm wide. Digital printers are able to print a high-resolution image with a speed exceeding 60 m/min. Major improvements of speed, resolution, investment costs and ink costs are made continuously.

DPI is used to define the printing quality of a digital printer. It describes the resolution in number of dots per inch in the digital print.

A relatively low resolution is typically below 100 DPI. This allows a high printing speed and a low ink content. A resolution of 200 DPI is generally sufficient to provide prints that may be used in flooring applications. 300 DPI is generally sufficient to for example print wood grains structures of the same quality presently used in conventional laminate floorings.

Industrial printers can print patterns with a resolution of 300-1000 DPI and even more.

The ink may be a “spot colour” ink. The ink has in such an embodiment been specifically produced and adapted to a specific colour suitable for a specific image. Instead of creating the colour by mixing pixels of CMYK-colours the ink creating the spot colour pixel has a specific predetermined colour.

The print may be a “full print.” This means that the visual printed décor is mainly created by the ink pixels applied into powder or on a paper surface. The colour of a powder layer or a base colour has in such an embodiment in general a limited effect on the visible pattern or décor.

The print may also be a “part print”. The colour of another underlying layer is one of the colours that are visual in the final décor. The area covered by printed pixels and the amount of ink that is used may be reduced and cost savings may be obtained due to lower use of ink and increased printing capacity compared to a full print design.

The print may be based on the CMYK colour principle. This is a 4-colour setup comprising cyan, magenta, yellow and black. Mixing these together will give a colour space/gamut, which is relatively small. To increase specific colour or the total gamut spot colours may be added. A spot colour may be any colour. Additional colours such as orange, green, blue, red, light grey, and light colours of magenta and cyan or white may be used. These colours may be used separately or in combinations. The colours are mixed and controlled by a combination of software and hardware.

New technology has been developed by Valinge Innovation AB that makes it possible to inject a digital print into a powder layer. A high definition print in a powder layer requires a specific software program in order to control the printing hardware and to adopt it to the specific ink, printing method, distance from the printing head to the powder layer and the powder that is used. This software program is hereafter called “Digital Powder Raster Image Process” or DP-RIP and it is used to control printing speed, ink drop position, ink drop size and shape.

DP-RIP:s can be developed that allow that a print or decor may be positioned in several dimensions in for example powder based surfaces horizontally and vertically in different depths. This may be used to create 3D effects when transparent fibres are used and to increase the wear resistance. A specific advantage is that the print is extending from the upper part of the surface layer and downward. This allows that a part of the print will always be at the surface even when a part of the surface is worn down. No protective layers are needed that disturbs the original design.

This new type of “Digital Injection Print” or DIP is obtained due to the fact that printing is made into a powder that is cured after printing. The print is embedded into the cured layer and is not applied on a layer as when conventional printing methods are used.

The DIP method may be used in all powder based materials, for example moulding compounds and similar plastic materials, which may be cured after printing. However, the DIP method is especially suitable to be used when the powder comprises a mix of wood fibres, and, optionally, for example, small hard wear resistant particles and a binder such as melamine formaldehyde resin. The surface layer may also comprise thermoplastic material, for example vinyl particles, which are applied in powder form on a substrate. This allows that the print may be injected in the vinyl powder particles. An improved design and increased wear resistance may be reached even in such materials.

A suitable printer head has to be used in order to obtain a high printing quality and speed in powder based layers and other layers as described above. A printer head has several small nozzles that can shoot droplets of inks in a controlled way. The size of each droplet may vary, dependent on ink type and head type, between normally 1-100 picolitres. It is possible to design print heads that may fire bigger drops up to 200 picolitres more. Some printer heads can shoot different droplet sizes and they are able to print a grey scale. Other heads can only shoot one fixed droplet size.

Different technologies may be used to shoot the drops out of the nozzle.

Thermal printer head technology use print cartridges with a series of tiny chambers each containing a heater, all of which are constructed by photolithography. To eject a droplet from each chamber, a pulse of current is passed through the heating element causing a rapid vaporisation of the ink in the chamber to form a bubble, which causes a large pressure increase, propelling a droplet of ink out through the nozzle to the substrate. Most consumer inkjet printers, from companies including Canon, Hewlett-Packard, and Lexmark use thermal printer heads.

Most commercial and industrial inkjet printer heads and some consumer printers such as those produced by Epson, use the Piezoelectric printer head technology. A piezoelectric material in an ink-filled chamber behind each nozzle is used instead of a heating element. When a voltage is applied, the piezoelectric material changes shape, which generates a pressure pulse in the fluid forcing a droplet of ink from the nozzle. Piezoelectric inkjet allows a wider variety of inks than thermal inkjet as there is no requirement for a volatile component, and no issue with kogation. A lot of ink types may be used such as dye inks, solvent based inks, latex inks or UV curable inks.

Inks for flooring applications are generally individually mixed together by using UV stable colour pigments and several chemicals. Water based inks comprising colour pigments are especially suitable and may provide a cost efficient printing method with high quality in many different materials.

The above description of various known aspects is the applicants' characterization of such, and is not an admission that any of the above description is prior art. Several of the technologies described above are known and used individually but not in all combinations and ways as described above.

The majority of conventional digitally printed floorings, except floors where injection print in powder is used, must have a transparent protective layer that is applied by rollers. The digital application technology is mainly used to obtain advantages related to the possibility to create a high-resolution image in a flexible way. However, the other aspects of the technology, mainly related to the possibility to apply a substance very precisely with a digital non-impact method, have not been fully utilized or developed, especially not in combination with substances that are not intended to create an image and that are intended to be applied in substantial quantities to protect an image, décor or surface structure such that they may be used for flooring application or other applications where similar properties are required.

It would also be an advantage if digital prints and digital embossing may be combined with decorative properties and structures provided by the basic decors and structures of a panel, for example a panel with a wood surface that may have a décor and structure that may be improved by a partial print and/or embossing. This may provide a higher surface quality in a cost efficient way.

EP 2 108 524 describes a method to produce coated panels with a surface comprising protrusions formed by two or more digital prints provided on top of each other.

WO 2011/064075 A2 describes a method for generating a three-dimensional structure on a surface. A panel with a printed decorative surface is coated with a radiation-curing transparent varnish that is applied with a digital ink jet method with the aim to create a structured layer. The structure is formed by using different drop sizes and several print layers. The structure may be synchronized with the printed decorative pattern and different gloss levels may be formed by the transparent ink. The printed decorative surface may be a paper, a foil or a coated board. A digital print may be applied on the digitally created structure and the print may be covered by a transparent protective layer applied by conventional rollers.

US 2011/0171412 describes a direct digital print applied on a HDF board. The optical characteristics of the board are at least partly visible and incorporated in the design of the décor layer. The décor is roller coated with a transparent protective layer.

JP 2008-265229 describes a method coating and providing a base material with a pattern. The base material, such as timber, a resin material or a film material, is coated with a flexible resin layer. A decorative pattern is formed by a hard protective layer, which is applied by inkjet coating on the flexible resin layer.

These methods are not suitable to be used in for example wood floorings where the protective layers are applied on individual panels and they cannot be used to provide a digital print or a digital embossing that forms a part of the final décor or surface structure and that has to be adapted to basic designs and structures of each individual panel.

### Objects and Summary

A general objective of certain embodiments of the invention is to provide a building panel, preferably a floor panel, and a method to produces such panels with a transparent protective surface, which has better and/or different design properties and/or cost structure than the known building panels.

A specific objective of at least certain embodiments is to improve the surface quality and design of wood building panels, especially wood floor panels, that generally are coated as individual panels, where each panel comprises considerable design variations and surface defects.

Another specific objective of at least certain embodiments is to provide an improved method for coating individual wood building panels such as wood floor panels, especially individual panels already provided with a mechanical locking system at their edges and/or bevels.

The above objectives are exemplary, and the embodiments of the invention may accomplish different or additional objectives.

A first aspect of the invention is a method of coating a building panel having a decorative surface of wood, comprising the steps of:
applying a UV curable coating layer with a digital print head on a decorative surface of wood of a building panel; and
curing the UV curable coating layer with UV light, thereby forming a transparent protective surface layer, wherein said decorative surface is visible through said transparent protective surface layer.

The building panel may be a floor panel.

The digital coating is a non-contact method that provide major advantages compared to the conventional roller coating method.

The building panel, such as floor panel, may be an individual panel having a size, which is essentially the same as the final building panel comprising machined edges.

The building panel such as a floor panel may comprise a mechanical locking system at two opposite edges.

The building panel may comprise a bevel at an edge.

The UV curable coating layer may a liquid polyurethane substance.

The UV curable coating layer may be water based UV cured polyurethane.

The curable coating layer may a radiation curable coating layer. The radiation curable coating layer may be cured by UV light, heat radiation, electron beam, etc.

The radiation curable coating layer such as a UV curable coating layer may comprise an acrylate or methacrylate monomer or acrylate or methacrylate oligomer. The radiation curable coating may comprise an acrylic resin. The acrylate or methacrylate monomer or acrylate or methacrylate oligomer may be an epoxy acrylate, an epoxy methacrylate, an urethane acrylate, an urethane methacrylate, a polyester acrylate, a polyester methacrylate, a polyether acrylate, a polyether methacrylate, an acrylic acrylate, an acrylic methacrylate, a silicone acrylate, a silicone methacrylate, a melamine acrylate, a melamine methacrylate, or a combination thereof. The above examples are examples of monomer or oligomers polymerised by radical reaction. The above monomers or oligomers may form a component of a radiation curable coating layer.

The surface may comprise digital print.

The digital print head may be a Piezo print head.

The digital print head may be designed to apply drops, preferably with a size of about 60-200 picolitres.

The UV curable coating layer may comprise wear and/or scratch resistant particles.

The UV curable coating layer may comprise a structured surface with cavities and protrusions.

The structured surface may be in register with the decorative surface.

A second aspect of the invention is a floor panel having a core, a surface layer comprising a wood material, a print and transparent layers. A lower transparent layer may be located below the print, and an upper transparent layer may be located above the print, the lower transparent layer may be a UV cured polyurethane, a part of the wood material surface and the print form a part of the visible surface layer. The print may be at least partly synchronized with the visible design and/or structure of an individual floor panel.

Such wood floors may have a very attractive design even in the case that low quality wood is used as the core. The print which is applied with a digital print head may be adapted to each individual floor panels and the print may be used to form an image and/or an embossing that improves the basic design or structure of the floor panel.

The upper transparent layer may be water based polyurethane.

The upper transparent top layer may be embossed.

The upper transparent layer may be embossed in register with the print.

A third aspect of the invention is a method of forming a decor on a building panel with a digital vision control system that provides digital input to a digital print head, comprising the steps of:
creating a digital image of a surface of a building panel by the digital vision control system;
using the digital vision control system to provide digital input to the digital print head based on said digital image;
digitally printing at least a part of said surface of the building panel with the digital print head and with a print that is at least partly adapted to the digital image of said surface of the building panel.

The major advantage is that a digital vision system may be used to analyse each individual panel and a computer program may guide print heads that apply a print on surface portions that need an improved design or structure.

The building panel may be a floor panel.

The print may comprise colour pigments.

The surface of the panel may comprise a transparent substance that is UV cured and that after curing forms an embossed structure.

The building panel and the production method according to embodiments of the invention make it possible to produce very advanced decorative patterns with high wear and impact resistance in a cost effective way with the digital non-impact coating method. Even randomly formed in register embossed structured surfaces may be formed with the digital coating method.

Embodiments and details of various aspects may be combined with embodiments and details of the other aspects.

A fourth aspect of the invention is a method of coating a building panel is provided, comprising the steps of:
forming a transparent protective surface layer by applying a UV curing coating layer with a digital coating head on a decorative surface of a building panel;
curing the coating layer with UV.

The building panel may be a floor panel. The decorative surface may be wood.

### BRIEF DESCRIPTION OF THE DRAWINGS

The invention will in the following be described in connection to embodiments and in greater detail with reference to the appended exemplary drawings, wherein,

FIGS. 1a-c illustrate known roll coating and digital printing method;

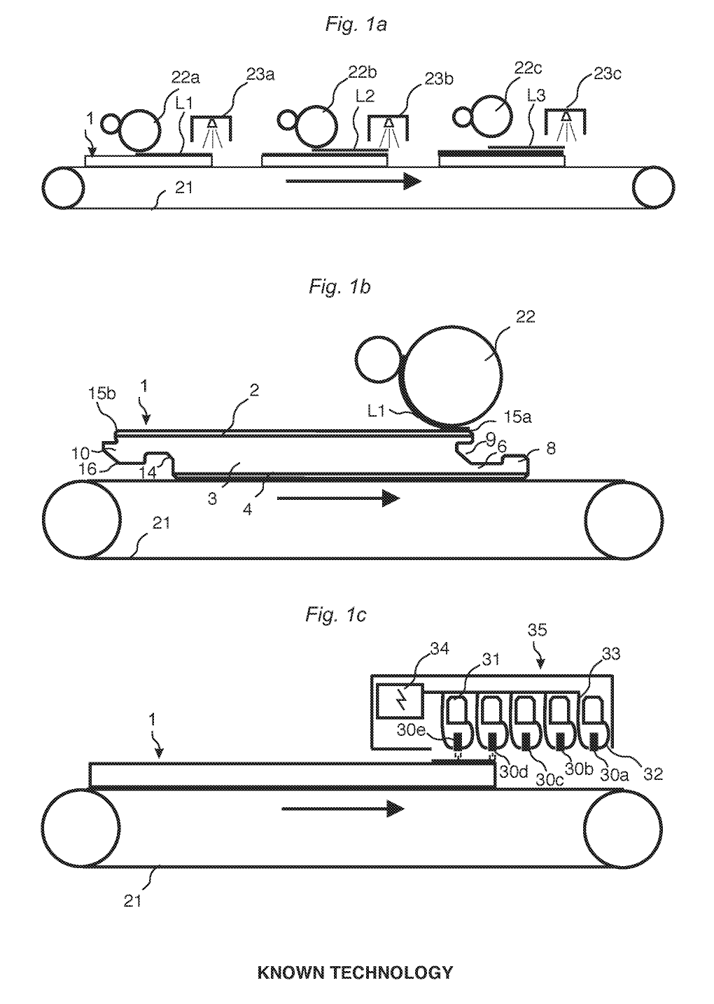

FIGS. 2a-b illustrate a digital coating method;

FIGS. 3a-c illustrate digital injection printing in transparent layers; and

FIGS. 4a-c illustrate digital printing and embossing.

### DETAILED DESCRIPTION OF EMBODIMENTS

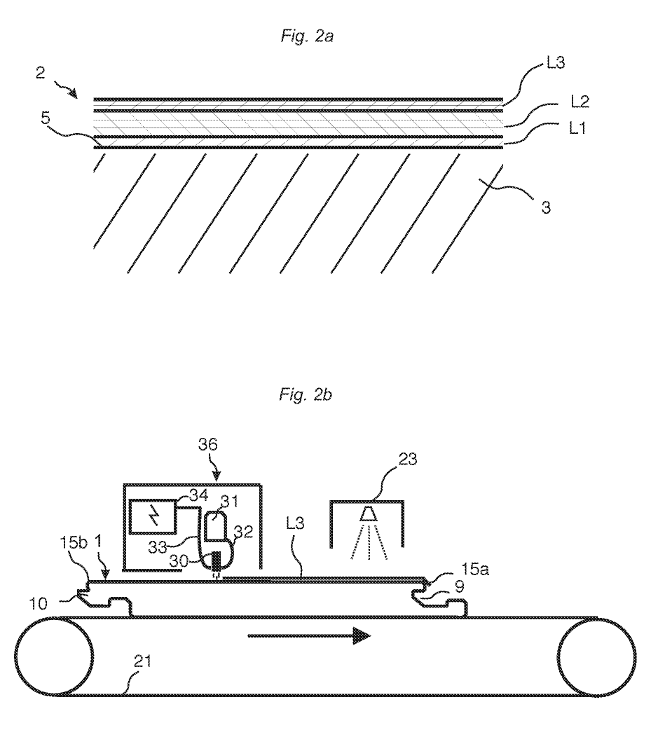

FIG. 2a shows a floor panel 1 comprising a core 3 of solid wood and a decorative surface 5 that is the upper part of the solid wood core. The floor panel 1 may comprise bevels 15a, 15b at edges of the floor panel 1. Several transparent layers of adhesion coat L1, base coat L2 and a top coat L3 are applied on the wood surface. The adhesion coat and the base coat are applied by rollers and UV cured. The topcoat is in this embodiment applied digitally.

The main principles of a digital coating method and equipment are shown in FIG. 2b. A digital coating unit 36 comprising a digital print head 30 used as a digital coating head. The digital print head 30 is preferably fixed. The digital print head 30 applies a transparent topcoat L3, preferably on a base coat L2. The digital application may be made without any contact between the panel and the digital print head 30, and the coating is applied as drops, which are fired from the digital print head 30 towards the decorative surface that may comprise an adhesive coat L1 under the base coat.

A UV curing oven 23 with ultra violet light is located preferably after the digital coating unit 36 in the feeding direction and may provide a practically instant curing within a few seconds of the coating, especially if a UV cured polyurethane coating with an appropriate photo polymerization initiator is used.

The digital print head 30, that preferably is a Piezo head, has preferably a capacity to fire drops with a drop size of about 50-200 picolitres or more. The drops may have a diameter of 30-100 microns or more and may create a drop spot on the surface that exceeds 100 microns. The drops are preferably positioned such that they overlap each other. The overlapping may be obtained by a combination of drop size and drop position. Several print heads located after each other in the feeding direction may also be used to create a continuous layer even when individual drops are applied in a raster pattern.

The UV curing coating is preferably a water based UV curable polyurethane substance with a viscosity that is adapted to the digital print head 30. Water-based polyurethane dispersions are preferred as coating used in the digital print head. They may be environmental friendly and technically superior to similar solvent-based coatings. They may be, for example, free of isocyanate and may have a zero or a very low volatile organic content. They have good properties related to hardness, stain and abrasion resistance, impact strength and temperature flexibility.

Polyurethane dispersions are fully reacted polyurethane/polyureas of small and discrete polymer particles and such particles may be produced with a size of about 0.01-5.0 microns and may therefore be handled in a digital Piezo print head or other similar heads. They may have 20-70% solid content and a wide range of layers with different hardness may be produced with a digital coating method. Polyurethane dispersions may be blended with for example acrylic emulsions in order to reduce costs in some applications. They may be also comprise small wear and scratch resistant particles, for example, aluminium oxide, that may be handled by the Piezo head. Such particles should be rather small since the nozzle opening in most digital print heads is about 10 microns. It is preferred that the wear resistant particles are smaller than 5 microns and it is even more preferable that the wear resistant particles are about 1 micron or smaller.

Wear resistant particles may preferably be applied by scattering the particles in dry powder form on, for example, the base coat that preferably is in a liquid state and not yet cured. A second base coat or a top coat may be applied on the wear resistant particle layer. The advantage is that large particles that may clog the nozzles are not applied by the digital print head. Separate scattering allows that particles with a size of 10-100 microns may be applied.

The coating is stored in liquid form in a coating container 31, which is connected to the digital print head 30 with a coat-feeding pipe 33. A digital control unit 34 connected to the print head and the conveyor with data cables 33 or wireless, controls the drop size and the speed of a conveyor 21 that displaces the panel 1 in relation to the digital print head 30.

Such a digital coating unit is much more cost efficient than a conventional digital printer since much larger drops may be fired and this gives an increased capacity and less problems with the channels in the head that may be sealed by larger particle in the ink when the printer works with high resolution and small drops. Each digital coating head formed as a digital print head may be designed to apply one layer only and there is no need to coordinate the drop application of such different print heads as in conventional multi-colour digital printing where drops aligned in a raster pattern side by side creates an digital image.

Special digital print heads may be design that allows applications of very large drops in the range of 200-400 picolitres and more and the nozzle opening may exceed 20 microns. Such digital print heads are generally not suitable to be used as conventional print heads aiming to create a high-resolution image. They may be designed to apply large overlapping drops in considerable quantities and in a cost efficient way. Each print head, that mainly is used as a digital coating head, may be designed to apply 10-20 gr/m2 or more in a single pass coating step.

The coating line may be very compact and the UV curing oven may be located close to the digital coating unit. The coating may be very precise and the non-impact method provides much better possibilities than roll coating to apply the UV curing coating on the edges, on bevels 15a, 15b formed at the edges, and on surfaces that are not completely flat such as for instance brushed or hand scraped wood surfaces or embossed laminated paper based or powder based floor. UV cured protective layers may be applied by a digital coating method on practically all type of floors in order to improve the surface properties or designs. Some parts of the surface may therefore, according to an embodiment of the invention, be formed with known methods to obtain the basic strengths, designs or structures and the final layers may be applied by digital coating. Floor with surfaces comprising paper, powder, cork, vinyl and even stone and tiles and similar may be digitally coated in order to improve the surface properties.

UV cured liquid coating offers the advantage that the coating is liquid until it is exposed to the UV light. This increases the productivity of the digital coating unit and many problems related to for example solvent inks may be avoided.

The digital coating equipment may of course have several print heads. The digital coating may be applied on individual panels or on a large sheet that after the coating is divided into several panels.

The above described principles may preferably be used to apply a base coat L2 and and/or the adhesion coat L1. It is possible to apply all transparent layers that are used to protect a wood surface or a printed image. Digital coating may be used to apply transparent layers with a film thickness that corresponds to 5-10 g/m2. Even thicker layers may be produced for example 10-20 g/m2 and a total thickness of about 100-120 g/m2 may be reached with 5-10 coating stations. The panel may also pass a coating station several times.

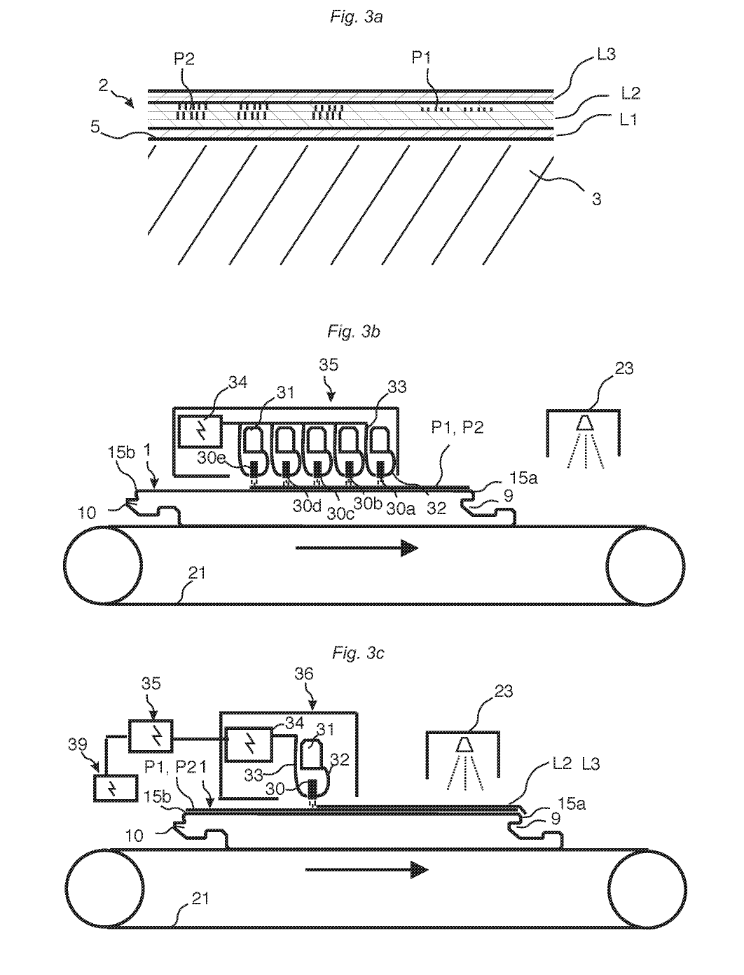

FIG. 3a shows that a digital print P1 may be applied on a transparent layer and such print is characterized in that a transparent layer L2 is located under the print and another transparent layer L3 may be located above the print P1. The panel surface, that preferably is the upper part of a wood material 5 may be visible and may together, with the print P1, form a part of the final surface décor and the decorative surface 2. The floor panel 1 may be provided with bevels 15a, 15b at its edges. At least the upper transparent layer is preferably applied by digital coating. A print P2 may also be injected into the wet transparent coating prior to the UV curing.

Such methods where a print P1 is applied on a transparent layer or when a print P2 is injected into a transparent layer may be used to obtain improved design properties since several images may be placed on top of each other with transparent layers between the prints and this may provide three dimensional images similar to a stone surface with transparent or semi-transparent crystals. Such three dimensional images may be partly or completely formed by conventional roller application methods that may be combined with digital printing or coating.

FIG. 3b shows a first production step of a combined digital printing and digital coating line. A digital print P1, P2 is applied on a cured layer or on a wet transparent layer. The print may be cured by UV 23, if the print, for example, is injected into a wet polyurethane layer.

FIG. 3c shows a digital coating unit 36 that may apply a transparent base coat or top coat on the digital print. The coat is UV cured in a UV oven 23. A transparent or semi-transparent adhesion coat may be applied digitally under the print.

It is an advantage if the digital coating unit 36 is connected, wireless or with a data cable, to a digital printing unit 35 as shown in FIG. 3c such that a digital print and a digital coating may be controlled and adapted to specific designs that are based on a combination of print and coating. A vision system 39 may also be digitally connected and digital coating and/or printing may be adapted to specific surface structures and designs. A vision system may for example be used in line with the printing and coating steps to create a digital image of a surface of a panel that preferably comprises a wood based surface 2. The panel may be an individual floor panel that may be a solid wood panel or a panel comprising a core covered by a wood layer with at thickness of for example 0.3-3 mm. Defects of the surface such as extreme deviations in colour, cracks, knots, repetitive effects etc. may be detected and analysed by the vision system 39, preferably by analysing the digital image of the surface of the panel and comparing the image with images already stored in the memory of the vision system. The system may be “intelligent” and new images and adjustment instructions may improve the efficiency. Specific software may be made for different wood species The visible surface of the panel may be at least partly digitally printed based on an analysis of the digital image such that defects are covered or adjusted with a digital print or that some surface portions are printed in order to create a more attractive wood design, such as creating an improved wood grain structure. As an alternative or complement to digitally printing, a transparent coating may be applied based on an analysis of the digital image. For example, the gloss grade of the surface of the panel may be changed and an increased amount of a liquid substance may be applied to cover cracks or cavities detected in the wood surface. The surface may be exposed to a various types of lights when a digital camera takes a picture and this may improve the possibilities to detect specific defects.

The Vision Controlled Digital Printing method as described above may also be used in other floor than wood floors. Conventionally printed paper or foil surfaces comprise repetition effects from the printing cylinders. Such effects may be partly eliminated by the vision controlled digital printing method. The method is preferably combined with a production step where the printed substrate is connected to a core prior the final digital printing step. A major advantage is that it is not necessary to position the already printed substrate in a precise manner on a panel since the exact position and/or the specific design may be detected by the vision system 39 and the digital printer may apply the complementary design with great accuracy. If paper is used, it is may be advantageous if such paper is a raw paper without any resins. The necessary thermosetting resins may be injected from a base layer under the substrate and/or from a top layer applied on the printed surface. The top layer may be a powder layer comprising wear resistant particles and thermosetting resins or a conventional overlay and the resins may be cured by heat and pressure. Digital coating as described above may also be used as top layer.

The VCDP method may also be used to create a décor in a WFF floor with a powder based surface. Powder comprising one or several colours may be scattered on a board and a basic design may be created. A vision system and a computer system may analyse the basic design and give necessary digital input to a digital printer that in a second step may adjust or improve the basic design. The advantage is that the basic design may provide the major part of the pigments and the amount of ink applied by the digital printer may be reduced considerably, preferably to a few g/m2, for example, 1-5 g/m2. In some applications ink content of 3 g/m2 or less may be sufficient. This method may also be used to create a surface design on a ceramic tile.

The VCDP method is very suitable to combine with a Binder And Powder printing method wherein a pattern or image may be formed digitally by an ink head that only applies a liquid binder on a surface without any pigments. The binder may be a water based substance comprising glycol that provides a suitable viscosity. The pigments are scattered randomly by a second device over the liquid pattern. The binder connects some pigments that form the same pattern as the binder while other non-bonded pigments are removed. This two-step process, where the pigments and a liquid binder are applied separately, may provide an image with the same quality as convectional digital printing technology and is a very cost efficient method to form a basic design that is adjusted or improved in a final digital printing step comprising pigment based ink, preferably water based inks. The powder may be a transparent substance, for example bleached wood fibres, and BAP may be used to create an embossed transparent surface.

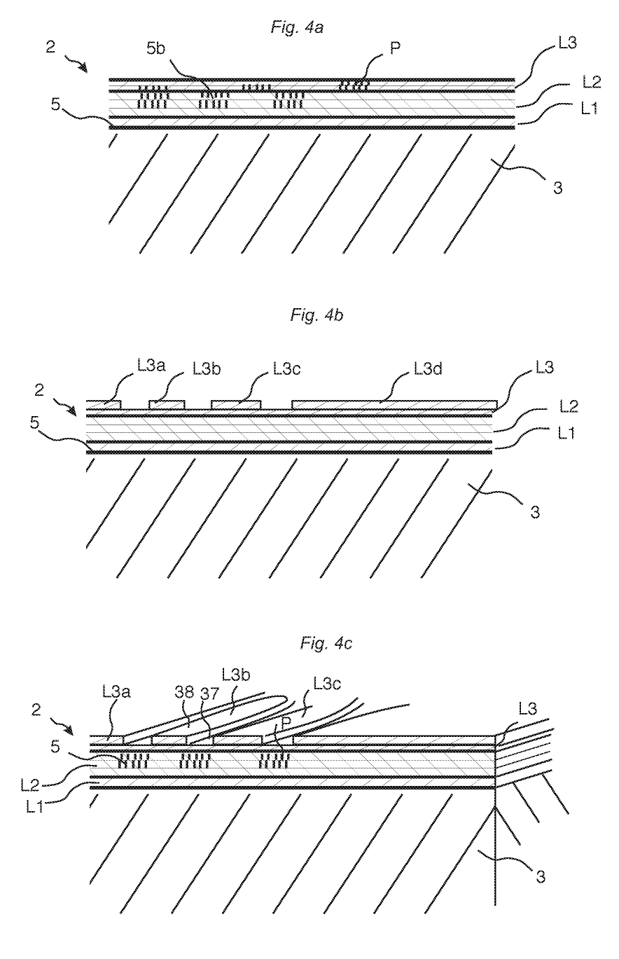

FIG. 4a shows that the digital print P may be applied to, or injected in, the top coat L3 and/or the base coat L2. The decorative surface 5 may be a wood layer, for example solid wood, a wood sheet or a wood veneer that may be glued to a core 3, for example a lamella core, HDF or plywood. The digital print is used to improve the design of the decorative surface.

FIG. 4b shows that digital coating may be used to provide a Digitally Embossed Surface, hereafter referred to as DES. A first top layer with a discontinuous cross section L3a-L3d may be provided that for example imitates a wood grain structure. The layer is applied in the form of a transparent image having a vertical extension. The wet three-dimensional structure may be UV cured and preferably a second or a third coating with a discontinuous structured cross section may be applied on the first layer. The discontinuous layers may be used to build a vertically extending structured surface with similar or different gloss levels. Embossed structures with for example a depth of about 0.1 mm and more may be formed with any shapes.

This method may be used to form advanced structures in a very flexible way and the embossing may be precisely coordinated with a printed surface, preferably a digital print as shown in FIG. 4c. The print P is coordinated with the structure L3a-c and individual parts of a digital image may be provided in well-defined surface structures where for example a particular grain is printed in a part of the surface that forms small cavities 37 and other parts of the image may be formed in the surface that comprises small protrusions 38. Such a Digital Embossed In Register Surface, hereafter referred to as DERIS technology makes it possible to create individual panels that are unique and without any repetition effect related to design or structures. Since no embossed cylinders or matrix films are needed, as in conventional technology, a wide variety of practically unlimited structured designs may be produced in a very flexible and cost efficient way.

DERIS is preferably used together with a digitally printed image. Such image may be printed on a paper, foil, on a board material or injected into powder-based surfaces as described above. The digital printer 35 and the coating unit 36 that forms the top layers L3 are preferably digitally connected to a computer that coordinate the surface design and the surface structure.

DERIS technology may even be used to coordinate an individual structured surface coating with individual wood panels that have different designs or with any other panels where a surface design or structure is already formed. This is an advantage especially in application where digital printing is used to improve the design of a wood surface. Wood species of lower quality may be improved by digital printing as described above. For example a digital picture of a wood surface of a panel may be made by the vision control system comprising a digital camera or scanner. This is preferably made in line prior to the application of the transparent coating that provides the final digital embossed surface. The vision control system may be used together with a computer program that may analyse the digital picture and may adjust the digital coating such that it is coordinated with the wood grain structure and design of each individual panel.

Such Vision Controlled Digital Embossing methods are not used in flooring applications. VCDP and VCDE may be combined and very cost efficient advanced decors and structures may be formed.

VCDE is especially suitable to form embossed structures on panels where parts of the décor are not formed digitally in line in a prior printing step. Even when this is the case, production efficiency and quality may be improved since there is no need to use high quality transportation units that moves the panel with high accuracy between different printing, coating and application steps that all must be coordinate in order to give a high final surface quality. The vision system that preferably also may be combined with a position system between different production steps may be very cost efficient compared to known methods.

All described embodiments may be combined and all transparent layers may comprise colour pigments.

The digital coating method may also be used to apply other chemicals on a panel, for example glue, preferably a water based glue.

The method to apply a UV cured polyurethane digitally in order to obtain 3D structures may also be used for other applications and not only building panels as described above. A digital printer and an UV oven may be used to apply and cure many layers of various types of UV cured polymers vertically in order to create complicated structures and models with a vertical extension of 1-10 mm and even more. A first layer may be applied on a substrate that is moved in an UV oven and back again thereafter a new layer is applied. Two digital Piezo heads may for example also be positioned with a UV oven in between and the substrate may move from a first print head through the UV oven and into the second print head and back again. This sequence may be repeated many times and each layer may be 0.1-0.3 mm thick or even more depending on the viscosity of the liquid polymer that for example may be polyurethane. In general no additional substances are needed to cure the polyurethane and the two printer heads may use the same type of UV cured liquid polyurethane. The two printers may also use different substances, which may be used to decrease the curing time. This production method may be combined with a visions system and partial 3D structures may be formed on specific well-defined portions of various objects that may comprise various materials. 3D structures may have different colours injected digitally into the UV cured polyurethane.

Such digital 3D methods may be used to provide a matrix that may be used as a sheet that provides an embossed structure when laminate and powder based floors are pressed in a press in order to cure the surface.

It is contemplated that there are numerous modifications of the embodiments described herein, which are still within the scope of the invention as defined by the appended claims.

It is for example contemplated that curing of the curable coating layer with UV may be replaced by another radiation curing method. It is also contemplated that the present invention may be used for other types of radiation curing coating layers.

As apparent from the description, the coating layer may be applied with the digital print head directly on the surface of the building panel forming the decorative layer, and may be applied on an intermediate layer arranged on the surface of the building panel.

### EXAMPLES

### Example 1

A digital image was applied on a panel comprising a HDF board. The image was created with a single pass printer comprising 5 fixed Piezo print heads. The ink was a water-based ink comprising colour pigments.

A Piezo print head with a drop size of 50 picolitres was used to apply a transparent layer of water based UV cured polyurethane that corresponds to a film of 10 g/m2.

The above material was cured in a UV oven and a digital image with a digitally coated transparent layer was obtained.

### Example 2

A digital image with a wood design was applied on a panel comprising a HDF board. The image was created with a single pass printer comprising 5 fixed Piezo print heads. The ink used was a water-based ink comprising colour pigments.

A Piezo print head with a drop size of 50 picolitres was used to apply a transparent layer of water based UV cured polyurethane that corresponds to a film of 10 g/m2.

The above material was cured in an UV oven.

A second similar transparent layer with a weight of 5 g/m2 was applied with a Piezo print head with a drop size of 50 picolitres. The layer was applied as a transparent image coordinated with the digital image.

The above material was cured in an UV oven and a wood grain design with a wood grain structure in register with the wood grain design was obtained.

Digital coating may also be used to seal the edges and/or the locking system 9, 10 against moisture, to eliminate squeaking sound, or to change friction properties of active surfaces in the locking system. The major advantage is that a liquid substance may be applied with high precision and unwanted over spraying on for example the surface may be avoided. A print head is generally used to apply a liquid substance vertical with a distance to the surface of a few mm. Print heads may be used to apply liquid substances from a distance of up to 10 mm and more and the application may be made in various angles against the surface for example 0-10, 10-20, 20-45 degrees or even more then 45 degrees from above or from below. This allows that locking systems with advanced geometries may be coated with combination of several print heads positioned in several angles. The liquid substance may be liquid wax that after cooling to room temperatures becomes a soft layer.

### EMBODIMENTS

1. A method of coating a building panel having a decorative surface of wood, comprising the steps of:
applying a UV curable coating layer with a digital print head on a decorative surface of wood of a building panel; and
curing the UV curable coating layer with UV light, thereby forming a transparent protective surface layer, wherein said decorative surface is visible through said transparent protective surface layer.

2. The method as in Embodiment 1, wherein the building panel is a floor panel.

3. The method as in Embodiment 1 or 2, wherein the building panel is an individual panel having a size, which is essentially the same as the final building panel comprising machined edges.

4. The method as in any one of the preceding Embodiments, wherein the building panel comprises a mechanical locking system at two opposite edges.

5. The method as in any one of the preceding Embodiments, wherein the building panel comprises a bevel at an edge.

6. The method as in any one of the preceding Embodiments, wherein the UV curable coating layer is a liquid polyurethane substance.

7. The method as in any one of the preceding Embodiments, wherein the UV curable coating layer is water based UV curable polyurethane.

8. The method as in Embodiment 1, wherein the decorative surface comprises a print.

9. The method as in any one of the preceding Embodiments, wherein the digital print head is a Piezo print head.

10. The method as in any one of the preceding Embodiments, wherein the digital print head is designed to apply drops, preferably with a size of about 60-200 picolitres.

11. The method as in any one of the preceding Embodiments, wherein the UV curable coating layer comprises wear and/or scratch resistant particles.

12. The method as in any one of the preceding Embodiments, wherein the UV curable coating layer comprises a structured surface with cavities and protrusions.

13. The method as in Embodiment 12, wherein the structured surface is in register with the decorative surface.

14. A floor panel having a core, a surface layer comprising a wood material surface, a print and transparent layers,
wherein a lower transparent layer is located below the print, and an upper transparent layer is located above the print, wherein the lower transparent layer comprises a UV curable polyurethane, and
wherein a part of the wood material surface and the print form a part of a visible surface and the print is at least partly synchronized with the visible design and/or structure of an individual floor panel.

15. A floor panel as in Embodiment 14, wherein the upper transparent layer comprises water based polyurethane.

16. A floor panel as in Embodiments 14 or 15, wherein the upper transparent layer is embossed.

17. A floor panel as in any one of the Embodiments 14-16, wherein the upper transparent layer is embossed in register with the print.

18. A method of forming a decor on a building panel with a digital vision control system that provides digital input to a digital print head, comprising the steps of:
creating a digital image of a surface of a building panel by the digital vision control system;
using the digital vision control system to provide digital input to the digital print head based on said digital image;
digitally printing at least a part of said surface of the building panel with the digital print head and with a print that is at least partly adapted to the digital image of said surface of the building panel.

19. The method as in Embodiment 18, wherein the building panel is a floor panel.

20. The method as in Embodiments 18 or 19, wherein the print comprise colour pigments.

21. The method as in any one of the Embodiments 18-20, wherein the surface of the building panel comprises a transparent substance that is UV cured and that after curing forms an embossed structure.

1. (canceled)

2. A method of coating a building panel, comprising the steps of:
applying at least one transparent layer on a decorative surface of wood of a building panel, each transparent layer being a UV curable coating layer; and
curing the at least one transparent layer with UV light, thereby forming a transparent protective surface layer,
wherein said at least one transparent layer comprises a digital print and a transparent digital coating.

3. The method according to claim 2, comprising applying the digital print on a transparent layer of the at least one transparent layer.

4. The method according to claim 2, comprising injecting the digital print into a transparent layer of the at least one transparent layer prior to the step of curing.

5. The method according to claim 2, wherein an upper transparent layer is applied by digital coating above the digital print.

6. The method according to claim 2, wherein a transparent layer of the at least one transparent layer is located under or above the digital print.

7. The method according to claim 2, wherein the transparent digital coating is applied by a digital print head.

8. The method according to claim 7, wherein the digital print head is configured to apply overlapping drops.

9. The method as claimed in claim 7, wherein the digital print head is configured to apply drops having a size of 60-200 picolitres.

10. The method according to claim 2, wherein the at least one transparent layer UV comprises a liquid polyurethane substance or water based UV curable polyurethane.

11. The method according to claim 2, wherein the decorative surface comprises a print.

12. The method according to claim 2, wherein the at least one transparent layer comprises color pigments.

13. The method according to claim 2, wherein an edge of the building panel comprises a bevel.

14. The method according to claim 2, wherein said decorative surface is visible through said transparent protective surface layer.

15. The method according to claim 2, wherein the at least one transparent layer comprises wear resistant particles and/or scratch resistant particles.

16. The method according to claim 2, the at least one transparent layer comprising a plurality of digital prints placed on top of each other with transparent layers between the digital prints, thereby providing a three-dimensional image.

17. The method according to claim 2, wherein the at least one transparent layer comprises a structured surface with cavities and protrusions.

18. The method as claimed in claim 17, wherein the structured surface is in register with the decorative surface.

19. The method as claimed in claim 2, wherein the building panel is a floor panel.
